(19) United States
(12) Patent Application Publication
(10) Pub. No.: US 2007/0184263 A1
(43) Pub. Date: Aug. 9, 2007

(54) ADHESIVE TAPE WITH TEAR PROPAGATION RESISTANCE

(75) Inventors: Ilse Rodewald, Hamburg (DE); Petra Yun, Hamburg (DE); Andreas Wahlers-Schmidlin, Guderhandviertel (DE); Norbert Grittner, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 11/548,366

(22) Filed: Oct. 11, 2006

(30) Foreign Application Priority Data
Oct. 12, 2005 (DE) 10 2005 049 343.2

(51) Int. Cl. B32B 7/12; B32B 27/04

(52) U.S. Cl. 428/354; 428/353; 442/149; 442/151

(57) ABSTRACT

Adhesive tape having a backing material applied to at least one side of which is an adhesive, in particular a pressure-sensitive adhesive, the backing material having a support backing composed of a polymeric film or of paper, and having a binder layer disposed between support backing and a layer of adhesive, characterized in that set into the binder layer in the lengthwise direction and entirely surrounded by the binder layer are non-twisted and non-tangled individual filaments.

The invention relates to a filament-reinforced adhesive tape, as described, for example in U.S. Pat. No. 2,750,315 A, and to its use.

The problem of the tear propagation resistance of adhesive tapes is well known. Solutions to this problem are based on different approaches: for example, on the fibre reinforcement of the backing material. Customary tapes include “filament” adhesive tapes with unidirectional lengthwise nonwoven scrims or bidirectional woven or nonwoven scrims, which are composed of twisted or tangled yarns. These yarns may be composed, for example, of synthetic continuous fibres or else of natural fibres. The fibres in this kind of adhesive tapes are often held together to form locally fixed fibre bundles or filament bundles. This local fixing is accomplished by embedding the nonwoven scrims or wovens into the relatively thick layer of adhesive. The thickness of this layer is selected such that the individual filaments or filament bundles lie entirely inside this layer and that there is neither direct contact between backing and filament nor emergence of the filaments from the adhesive on the bonding side of the tape. As described in U.S. Pat. No. 2,750,315 A, the adhesive tape is applied to this end in two layers, between which the fibres are laid. According to the process described in U.S. Pat. No. 2,750,315 A use is made not only of nonwoven scrims and wovens composed of filament bundles but also of nonwoven scrims composed of individual filaments. Effective penetration of the wovens/nonwoven scrims by the adhesive thus produces a homogeneous layer of adhesive that completely envelops the fibres. In the medical sector in particular there has already been disclosure of reinforced backing materials.

Thus AU 73555/74 A describes exemplarily a glass thread-reinforced backing material for medical applications. U.S. Pat. No. 4,668,563 A likewise describes a material reinforced with glass fibre. DE 197 29 905 A1 discloses a substantially inelastic backing material based on wovens or knits to which high-strength fibres, folded yarns, folded union yarns or threads—made of a material both with an organic and an inorganic basis—having an ultimate tensile stress strength of at least 60 cN/tex, preferably 80 to 500 cN/tex, are added, the high-strength fibres, folded yarns, folded union yarns or threads exhibiting water absorption of less than 10%, preferably less than 5%, more preferably less than 3%, and the high-strength fibres, folded yarns, folded union yarns or threads giving the backing material an ultimate tensile stress strength of at least 50 N/cm, preferably 60 to 450 N/cm, more preferably 65 to 250 N/cm. The backing material may be reinforced here with one thread or with two or more threads of monofill, multifill, staple fibre yarn or spun fibre yarn and/or with oriented high-strength fibres. It is also possible in addition to use folded yarns or folded union yarns, especially Sirospun yarns. For specific application, use may also be made of fibre-blend threads and fibre-blend folded or non-folded yarns. These may be, for example, core-spun yarns, including special staple fibre core-spun yarns. It is advantageous that, by combining high-strength reinforcements with base materials, it is possible to achieve specific properties in the reinforcement thread itself. Examples of this are the combinations of glass or carbon and cotton or staple viscose rayon. The fibres or threads here can be composed of organic or inorganic materials: thus, for example, and preferably, of glass, carbon or special polyamides. The backing material is further preferably laminated with the threads and/or high-strength fibres. The threads and/or the high-strength fibres ought to be firmly connected to the backing material. This can be done by direct incorporation or insetting of the fibres, threads, folded yarns or folded union yarns into the backing, such as by weaving them in the case of wovens, knitting them in the case of knits, or embedding or inserting them in the case of the production process of films, nonwoven scrims or foam materials and batts. Alternatively the fibres or high-strength threads can be connected to the backing subsequently; for example, mention may be made of their welding or lamination to a corresponding connection layer. Laying them into the layer of adhesive is one appropriate means of achieving this.

It is an object of the invention to provide an adhesive combining comparatively low thickness with very high tear propagation resistance in the cross direction (crosswise direction, cd) and very high tensile strength in the lengthwise direction (machine direction, md).

This object is achieved by means of an adhesive tape as laid out in Claim 1. The dependent claims provide developments of the adhesive tape of the invention, and uses thereof. The invention accordingly provides an adhesive tape having a backing material applied to at least one side of which is an adhesive, in particular a pressure-sensitive adhesive, the backing material having a support backing composed of a polymeric film or of paper, and having a binder layer disposed between support backing and a layer of adhesive. Set into the binder layer in the lengthwise direction and entirely surrounded by the binder layer are non-twisted and non-tangled individual filaments.

The individual filaments are preferably continuous filaments and/or have a linear density of between 4 and 8 dtex, preferably 5 dtex. In one advantageous embodiment all the filaments are continuous filaments. Ideally, the filaments are in the closest spherical packing, so that there are no gaps, or virtually no gaps, between the filaments encased by the binder. In one preferred embodiment there are between 400 and 800 filaments per centimetre width in the backing material, in particular between 500 and 600, very preferably 550.

It has further proved to be advantageous if the individual filaments are disposed regularly in one ply parallel to the support backing or at most in three plies parallel to the support backing, and if the filaments have a linear density of 4 to 8 dtex. In each ply the filaments are arranged in parallel adjacent to one another. In another advantageous embodiment, the individual filaments are disposed regularly in one ply parallel to the support backing or at most in five plies parallel to the support backing, and the filaments have a linear density of 2 to 6 dtex.

Depending on the desired end use, more than five plies of filaments are also possible; as the number goes up there is an increase in the thickness of the backing material, but also in the strength at the same time.

The individual filaments ought then to be composed preferably of high-strength fibres with low breaking extension, such as glass fibres or carbon fibres, for example, or else of drawn polymer fibres, such as polyester fibres, polypropylene fibres, polyethylene fibres, polyamide fibres or aramid fibres.

As a result of the lack of twisting and tangling of the parallel arrangement aligned in the lengthwise direction, this lack having been recognized as being advantageous, the length of the filaments corresponds almost exactly to the running length of the backing material, and hence to the minimum of the theoretical possible length. A parallel tensile force on the adhesive tape thus acts on each filament directly, and at the same time is taken on by numerous filaments, in conformity with what is desired. This results in a particularly effective pick-up of force.

As a result of the lack of twisting and tangling, the filaments, additionally, are able to react to a non-parallel tensile load with an individual change in length. This results in an optimum distribution of force across the width of the adhesive tape.

In contrast to the process known from U.S. Pat. No. 2,750,315 A, in the case of the present invention, a fibre-reinforced backing is produced first of all. This is done by laying individual filaments adjacent to one another in parallel in an ordered disposition, lengthwise with respect to the machine direction, and fixing them on a backing material by means of a binder, in particular by means of a non-adhesive impregnation system. The individual filaments are positioned parallel as precisely as possible, to produce a unidirectional layer of filament that is composed of one ply or a few plies one above another. Instead of merely laying the filaments onto a continuous layer of adhesive, the filaments are impregnated completely by the low-viscosity binder and thus subsequently fixed on the backing.

In contradistinction to the material described in U.S. Pat. No. 2,750,315 A the filaments, in accordance with the invention, are not in the adhesive. By virtue of the binder they are, instead, an integral component of the backing material, so that there is no direct contact between filament and adhesive. Binder and adhesive therefore constitute two layers, which can be adapted completely independently of one another to the particular function required—an advantage that cannot be realized with the adhesive tape U.S. Pat. No. 2,750,315 A discloses. The binder comprises blends based on SBR or acrylate. Preference is given to an aqueous, plasticizer-free anionic dispersion of an acrylic ester copolymer containing carboxyl groups (Acronal® 500 D). In one advantageous embodiment, the binder is applied to the support sheet at 10 to 30, preferably 10 to 20, more preferably 15 to 17 g/m². In addition to the fixing of the filaments, the binder may take on functions of a functional layer. It may act as a primer, between the support backing (film/paper)/filament/adhesive interfaces which occur.

It may take on the functions of a barrier layer: for example, by integration of UV absorbers the UV protection of the adhesive. The binder may be designed as a reactively curing binder system, so that it exerts little or no influence on the adhesive. At the same time it is possible to adjust the hardness of the binder through the reactive components. Adjustable binder hardnesses and adjustable adhesive cohesiveness can be obtained by means of migrating crosslinkers.

Finally, the binder can be adapted, in respect of backing and fibres used, for achieving an optimum composite in respect of
its viscoelastic behaviour
its hardness/stiffness
the strength of the overall backing, principally in the z direction,
its optical properties.

The latter property is advantageous insofar, for example, as the colour of the adhesive tape can easily be varied. In the case of a transparent support backing the pressure-sensitive adhesive as a whole is usually coloured, to give a coloured adhesive tape. In accordance with the invention, it is enough to equip the binder with the desired colour.

Through the use of the binder of the invention, non-adhesive facing material is produced which is easy to handle and store.

Suitable support backing materials include (crepe) papers, laminates, films, (for example, BOPP, MOPP, PP, PE, PET, PA, PU, PVC), foam materials, and foamed or metalized films. The films themselves may in turn be composed of two or more individual plies—for example, plies coextruded to form film. Preference is given to polyolefins, although copolymers of ethylene and polar monomers such as styrene, vinyl acetate, methyl methacrylate, butyl acrylate or acrylic acid are also included. The polymer may be a homopolymer such as HDPE, LDPE, MDPE or a copolymer of ethylene with a further olefin such as propene, butene, hexene or octene (for example LLDPE, VLDPE). Also suitable are polypropylenes (for example, polypropylene homopolymers, random polypropylene copolymers or block polypropylene copolymers). The film may be unoriented. Outstandingly suitable for use as films in accordance with the invention are monoaxially and biaxially oriented films. Monoaxially oriented polypropylene, for example, is notable for its very high breaking strength and low extension in the lengthwise direction, and is used, for example, to produce strapping tapes. Monoaxially oriented films based on polypropylene are possible. Particular preference is given to films based on polyester.

Suitable support backings have a thickness of preferably up to 50 μm, more preferably 5 to 25 μm, very preferably 5 to 15 μm.

The adhesive of the adhesive tapes of the invention may be a (self-)adhesive from the group of the natural rubbers or synthetic rubbers, or is composed of any desired blend of natural rubbers and/or synthetic rubbers, it being possible for the natural rubber or rubbers to be selected in principle from all available grades, such as, for example, crepe, RSS, ADS, TSR or CV grades, depending on required purity and viscosity level, and for the synthetic rubber or rubbers to be selected from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof.

For further preference it is possible to improve the processing properties of the rubbers by adding thermoplastic elastomers to them with a weight fraction of 10 to 50% by weight based on the total elastomer fraction. Representatives that may be mentioned at this point include in particular the especially compatible styrene-isoprene-styrene (S IS) and styrene-butadiene-styrene (SBS) grades.

In addition, a 100% system based on styrene-isoprene-styrene (SIS) has proved to be suitable.

Tackifying resins which can be used include, without exception, all tackifier resins already known and described in the literature. Representatives that may be mentioned include the rosins, their disproportionated, hydrogenated, polymerized, and esterified derivatives and salts, the aliphatic and aromatic hydrocarbon resins, terpene resins and terpene-phenolic resins. Any desired combinations of these and further resins may be used in order to adjust the properties of the resultant adhesive in accordance with requirements. Explicit reference may be made to the depiction of the state of knowledge in the “Handbook of Pressure Sensitive Adhesive Technology” by Donatas Satas (van Nostrand, 1989).

Crosslinking is advantageous for improving the removability of the adhesive tape after the application, and may take place thermally or by irradiation with UV light or electron beams. For the purpose of thermally induced chemical crosslinking it is possible to employ all known thermally actuable chemical crosslinkers, such as accelerated sulphur systems or sulphur donor systems, isocyanate systems, reactive melamine, formaldehyde and (optionally halogenated) phenol-formaldehyde resins and/or reactive phenolic resin systems or diisocyanate crosslinking systems with the corresponding activators, epoxidized polyester resins and acrylate resins, and also combinations of these. The crosslinkers are activated preferably at temperatures above 50° C., in particular at temperatures of from 100° C. to 160° C., very preferably at temperatures of 110° C. to 140° C. Thermal excitation of the crosslinkers may also take place by means of IR rays or high-energy alternating fields.

An adhesive which has proven to be advantageous is one based on acrylate hotmelt, on solvent or on water, it being possible for the former to have a K value of at least 20, in particular more than 30, and obtainable by concentrating a solution of such an adhesive to give a system which can be processed as a hotmelt. Concentration may take place in appropriately equipped tanks or extruders; in the case of accompanying devolatilization, a devolatilizing extruder is particularly preferred. An adhesive of this kind is set out in DE 43 13 008 A1, whose content is hereby incorporated by reference to be part of this disclosure and invention. Alternatively, the acrylate hotmelt-based adhesive can be chemically crosslinked.

In one particularly preferred embodiment the self-adhesives used are copolymers of (meth)acrylic acid and the esters thereof having 1 to 25 carbon atoms, maleic, fumaric and/or itaconic acid and/or their esters, substituted (meth)acrylamides, maleic anhydride and other vinyl compounds, such as vinyl esters, especially vinyl acetate, vinyl alcohols and/or vinyl ethers. The residual solvent content should be below 1% by weight. One adhesive which is found to be particularly suitable is a low molecular mass acrylate hotmelt pressure-sensitive adhesive of the kind carried under the name acResin UV or Acronal®, especially Acronal® DS 3458, by BASF. This low-K-value adhesive acquires its application-compatible properties by means of a concluding, radiation-induced chemical crosslinking.

Finally, it may be mentioned that polyurethane-based adhesives are also suitable.

A single-sided adhesive tape can be used with particular advantage, the application of adhesive being preferably between 15 to 60 g/m², more preferably between 20 to 30 g/m².

The adhesive tape, finally, may have a liner material, with which the one or two layers of adhesive are lined until use. Suitable liner materials include all of the materials listed in detail above. Preference, however, is given to using a non-fluffing material such as a polymeric film or a well-sized, long-fibred paper. The side of the adhesive tape that possibly is not coated with adhesive can then carry customary primers.

In its mode of basic functioning, the invention is based on the fibre reinforcement of adhesive tapes for the purpose of increasing the tear propagation resistance.

As compared with the known backing materials comprising woven or comprising nonwoven scrim, of the kind used in the medical sector and reinforced by means of filaments (cross-filament tape), the adhesive tape of the invention exhibits considerable advantages. As a result of the weave structure of a woven in a backing, for example, the warp threads experience additional deflection in the z direction at the nodal points in said structure. In the event of tensile load, this additional length must first be extracted before the tensile properties of the yarn come to bear. In the present case, in contrast, the load acts directly on the support backing of film or paper and filaments in unison, thereby enabling optimum force pick-up.

Within the backing material there are a very large number of filaments disposed parallel adjacent to one another, leading to a very homogeneous product construction. If a few filaments are damaged in the edge region, the tear stops directly at the next filament, i.e. in the immediate vicinity of the original end of the tear (the extent of damage corresponds to the ultimate depth of inward tearing). Moreover, there is virtually no reduction in the tear strength of the backing material as a result of the loss of the small number of filaments; the adhesive tape retains its outstanding properties.

In the case of an adhesive tape with just a few filament yarns incorporated into its backing, the tear is able to propagate very much further, namely, until it reaches the next yarn. Furthermore, the loss of one yarn may imply a considerable structural weakening.

On the other hand, the regular distribution of the same number of filaments over the area in cross section levels the thickness. This levelling leads to a reduction in the maximum backing thickness of the adhesive tape.

The position—recognized as being advantageous—of the individual filaments in a ply aligned parallel to the support backing, or at most in three, and also the regular distribution which is preferred at the same time, produces a further advantage.

In order to be adhesive, a pressure-sensitive adhesive requires a certain minimum layer thickness, irrespective of the nature of the pressure-sensitive adhesive. This minimum layer thickness must be achieved over the entire width of the adhesive tape. If there is an uneven distribution of fibres, as in the case of fibre bundles, for example, the highest point in the cross section of the adhesive tape determines the necessary coatweight, since the required minimum layer thickness must be present on the fibre backs and/or on the nodal points in open filament wovens as well. A large quantity of adhesive is lost to no effect in filling up the gaps between the fibre bundles.

A further advantage of the present invention derives, consequently, from the fact that, as a result of the uniform arrangement of the filaments, there are no voluminous gaps between them, which would have to be filled up in order to achieve the minimum layer thickness over the entire width of the adhesive tape. Since all of the adhesive is effectively available for the bonding performance, less adhesive can be used for the same bond strength, resulting in a saving in material terms and hence in not only cost but also weight.

This composite material has the advantage that, by virtue of the skilful combination of the backing, binder and fibre components, it affords a free choice of adhesive. Since, as a result of this innovative backing composite material, the pressure-sensitive adhesive itself is no longer required to take on the function of fixing the fibres on the backing, it can now be freely selected according to technical bonding requirements. All that is necessary is chemical compatibility between adhesive and binder.

The steps specified above lead to a backing material having a strength of at least 250 N/mm² for 60 μm, in particular 300 N/mm² for 60 μm.

This strength increases as the thickness goes up, since the fibre fraction rises more than proportionally to the material as a whole. The adhesive tape features considerable tensile strength and also tear propagation resistance in cross direction. Furthermore, it has only low stretchability, and possesses all of these features in tandem with a very low thickness.

The steps specified above lead to adhesive tapes having a high strength and yet a thickness which is well below that of prior art adhesive tapes for corresponding fields of use. Thus it is possible to produce adhesive tapes of below 140 μm, in particular below 100 μm, very particularly of below 60 μm, and to do so, surprisingly, while retaining comparable tear strength.

The adhesive tape of the invention can be used with advantage in the fields of application as described in U.S. Pat. No. 2,750,315 A. These include, for example, bundling, packaging, palletizing, use similarly to a tightening belt, etc. The feature common to said applications is the fixing of one or more articles to itself or themselves, to one another or to further objects.

Besides the abovementioned applications the adhesive tape is outstandingly suitable for all functions requiring a reinforcing action of load-bearing elements in combination or, selectively, individually with resistance to inward tearing and to tear propagation. Materials which can be reinforced include, for example those such as paper, corrugated board or solid board, preferably at exposed positions such as grips, handles and cutouts. The tape can also be used as a constructional element for example, in order to prevent relatively heavy packaging from becoming floppy. The advantages of the coloured binder layer come to bear particularly on paper or board. If there is some transfer of adhesive when the adhesive tape is removed, and if this transferred adhesive remains on the substrate, it is preferably transparent and hence virtually invisible, whereas the adhesive tape is covered as a result of the binder. This produces advantages such as
the upgrading of packaging for greater challenges
the reduction in the total amount of material used, as a result of deliberate strengthening of the zones of principal loading
an increase in the useful life of packaging

### The invention is illustrated in more detail by reference to the figure described below, without any intention to restrict the invention unnecessarily as a result.

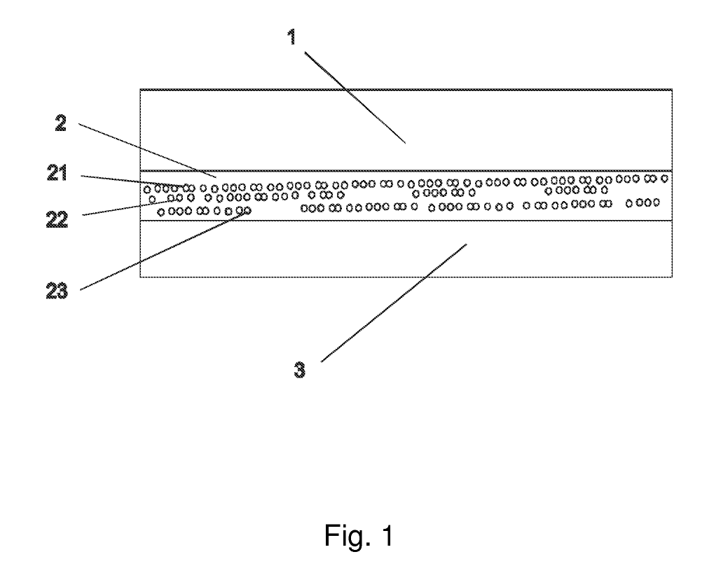

FIG. 1 shows the adhesive tape in a side section.

The adhesive tape comprises a backing material, applied to at least one side of which is an adhesive 3, in particular a pressure-sensitive adhesive. The backing material is composed of a support backing 1, comprising a polymeric film, and of a binder layer 2, which is disposed between support backing 1 and the one layer 3 of adhesive. Within the binder layer 2 there are a total of three plies 21, 22, and 23, of individual filaments, the plies 21, 22, and 23 being aligned parallel to the support backing. Each filament here is fully enclosed by the binder 2. The filaments in the plies 21, 22, and 23 are each arranged in parallel here, the filaments preferably being virtually in direct contact with one another.

1. Adhesive tape comprising a backing material and a layer of an adhesive applied to at least one side of said backing material, the backing a material comprising a support backing composed of a polymeric film or of paper, and comprising a binder layer disposed between the support backing and the layer of adhesive, wherein
set into the binder layer in a lengthwise direction and entirely surrounded by the binder layer are non-twisted and non-tangled individual filaments.

2. Adhesive tape according to claim 1, wherein
the individual filaments are continuous filaments and/or have a linear density of between 4 and 8 dtex.

3. Adhesive tape according to claim 1, wherein
the individual filaments are disposed in one ply parallel to the support backing or at most in three plies parallel to the support backing.

4. Adhesive tape according to claim 1, wherein the individual filaments are composed of glass fibers, carbon fibers, polyester fibers, polypropylene fibers, polyethylene fibers, polyamide fibers or aramid fibers.

5. Adhesive tape according to claim 1, wherein
there are between 400 and 800 filaments per centimeter width of the backing material.

6. Adhesive tape according to claim 1, wherein
the binder is applied to the support sheet at 10 to 30 g/m².

7. Adhesive tape according to claim 1, wherein
the support backing has a thickness of up to 50 μm.

8. Adhesive tape according to claim 1, wherein
the amount of adhesive on the backing material is between 15 to 60 g/m².

9. Adhesive tape according to claim 1, wherein
the backing material exhibits strength of at least 250 N/mm² for 60 μm thickness.

10. A bundle, package or pallet comprising the adhesive tape according to claim 1.

11. A paper, corrugated board or solid board reinforced with an adhesive tape according to claim 1.
